(19) United States
(12) Patent Application Publication
(10) Pub. No.: US 2017/0238221 A1
(43) Pub. Date: Aug. 17, 2017

(54) CELL AVOIDANCE ASSOCIATED WITH LOWER LAYER FAILURES

(71) Applicant: QUALCOMM Incorporated, San Diego, CA (US)

(72) Inventors: Arvind Vardarajan Santhanam, San Diego, CA (US); Daniel Amerga, San Diego, CA (US); Scott Allan Hoover, Del Mar, CA (US); Tian Mai, San Diego, CA (US); Arun Prasanth Balasubramanian, San Diego, CA (US); Muthukumaran Dhanapal, San Diego, CA (US); Vamsee Krishna Somavarapu, Neptune City, NJ (US); Srinivasan Balasubramanian, San Diego, CA (US)

(21) Appl. No.: 15/428,924

(22) Filed: Feb. 9, 2017

(30) Foreign Application Priority Data
Feb. 12, 2016 (IN) 201641004993

(51) Int. Cl. H04W 36/08; H04W 36/24

(52) U.S. Cl. CPC H04W 36/08; H04W 36/245

(57) ABSTRACT

Methods, systems, and devices for wireless communication are described. A user equipment (UE) may determine that a number of access stratum (AS) operations or communications have failed while attempting to communicate with a cell. Based on the AS failures, the UE may deprioritize the cell. For example, based on the deprioritization, the UE may bar certain cells from selection or reselection procedures. The UE may thus attempt to select or reselect a different cell even if the cell is ranked lower based on a selection criteria or reselection criteria. In some cases, UEs may store and share historical AS failure information that may also be used to determine when to deprioritize a cell. In some cases, a group of cells may be deprioritized (e.g., a group based on frequency, network, or tracking area).

### CROSS REFERENCES

The present Application for Patent claims priority to India Provisional Patent Application No. 201641004993 by Santhanam et al., entitled “Cell Avoidance Associated With Lower Layer Failures,” filed Feb. 12, 2016, assigned to the assignee hereof, and is hereby expressly incorporated by reference herein in its entirety.

### BACKGROUND

The following relates generally to wireless communication and more specifically to cell avoidance associated with lower layer failures.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as user equipment (UE).

In some cases a UE may maintain a list of cells from one or more base stations as candidates for a cell selection or reselection process. Cells may be ranked based on selection criteria (S-criteria) or reselection criteria (R-criteria). However, a UE may experience a communication failure while attempting to connect or communicate with a cell that is ranked highly based on the S-criteria or R-criteria. This may result in repeated attempts to select an unsuitable cell, which may in turn cause connection delays or disruptions.

### SUMMARY

A user equipment (UE) may determine that a number of access stratum (AS) operations or communications have failed while attempting to communicate with a cell. Based on the AS failures, the UE may deprioritize the cell. Based on the deprioritization, the UE may then attempt to select or reselect a different cell even if the cell is ranked lower than other candidates based on a selection criteria (S-criteria) or reselection criteria (R-criteria). In some cases, UEs may store and share historical AS failure information that may also be used to determine when to deprioritize a cell. In some cases, a group of cells may be deprioritized.

A method of wireless communication is described. The method may include determining that a number of failures in AS operations for a first cell have exceeded a threshold, deprioritizing the first cell relative to a priority of a second cell based at least in part on the determination that the number of failures have exceeded the threshold selecting a second cell based at least in part on the deprioritization of the first cell, and communicating with the second cell based at least in part on selecting the second cell.

An apparatus for wireless communication is described. The apparatus may include means for determining that a number of failures in AS operations for a first cell have exceeded a threshold, means for deprioritizing the first cell relative to a priority of a second cell based at least in part on the determination that the number of failures have exceeded the threshold, means for selecting a second cell based at least in part on the deprioritization of the first cell, and means for communicating with the second cell based at least in part on selecting the second cell.

A further apparatus is described. The apparatus may include a processor, memory in electronic communication with the processor, and instructions stored in the memory. The instructions may be operable by the processor to cause the apparatus to determine that a number of failures in AS operations for a first cell have exceeded a threshold, deprioritize the first cell relative to a priority of a second cell based at least in part on the determination that the number of failures have exceeded the threshold, select a second cell based at least in part on the deprioritization of the first cell, and communicate with the second cell based at least in part on selecting the second cell.

A non-transitory computer readable medium for wireless communication is described. The non-transitory computer-readable medium may include instructions executable to determine that a number of failures in AS operations for a first cell have exceeded a threshold, deprioritize the first cell relative to a priority of a second cell based on the determination that the number of failures have exceeded the threshold, and select a second cell based on the deprioritization of the first cell, and communicate with the second cell based at least in part on selecting the second cell.

Some examples of the method, apparatus, or non-transitory computer-readable medium described above may further include processes, features, means, or instructions for determining that a timer associated with a non-access stratum (NAS) procedure has expired, where the deprioritization of the first cell is based on the expiration of the timer associated with the NAS procedure. In some examples of the method, apparatus, or non-transitory computer-readable medium described above, the timer associated with the NAS procedure comprises an evolved packet system (EPS) mobility management (EMM) timer.

In some examples of the method, apparatus, or non-transitory computer-readable medium described above, the failures in AS operations comprise at least one of a random access operation failure, a radio resource control (RRC) connection attempt failure, an expiry of an RRC connection timer, a system information block (SIB) decode failure, or any combination thereof. In some examples of the method, apparatus, or non-transitory computer-readable medium described above, the first cell is deprioritized by reducing a priority level of the first cell relative to a priority of the second cell.

Some examples of the method, apparatus, or non-transitory computer-readable medium described above may further include processes, features, means, or instructions for ranking the first cell among a set of deprioritized cells based on the number of failures in AS operations for the first cell.

In some examples of the method, apparatus, or non-transitory computer-readable medium described above, a set of non-deprioritized cells is ranked over a set of deprioritized cells on a same frequency, and where set of non-deprioritized cells comprises the second cell and the set of deprioritized cells comprises the first cell. In some examples of the method, apparatus, or non-transitory computer-readable medium described above, a set of non-deprioritized cells is prioritized over a set of deprioritized cells on a different frequency, and where set of non-deprioritized cells comprises the second cell and the set of deprioritized cells comprises the first cell.

In some examples of the method, apparatus, or non-transitory computer-readable medium described above, a duration of the deprioritization of the first cell is based on the number of failures in AS operations exceeding the threshold within a designated time period. In some examples of the method, apparatus, or non-transitory computer-readable medium described above, the designated time period comprises at least one of an hour, a day, or a week, or any combination thereof.

Some examples of the method, apparatus, or non-transitory computer-readable medium described above may further include processes, features, means, or instructions for determining that the duration of the deprioritization has passed. Some examples of the method, apparatus, or non-transitory computer-readable medium described above may further include processes, features, means, or instructions for reprioritizing the first cell cased at least in part on the determination that the duration has passed.

In some examples of the method, apparatus, or non-transitory computer-readable medium described above, the determination that the deprioritization has passed is based on an RRC connected mode mobility operation to the first cell. In some examples of the method, apparatus, or non-transitory computer-readable medium described above, a duration of the deprioritization of the first cell is based on a type of AS operations that have failed in excess of the threshold.

Some examples of the method, apparatus, or non-transitory computer-readable medium described above may further include processes, features, means, or instructions for receiving AS operation failure information associated with at least one other UE at the first cell, where the deprioritization of the first cell is based on the received AS operation failure information. Some examples of the method, apparatus, or non-transitory computer-readable medium described above may further include processes, features, means, or instructions for storing AS operation failure information for the first cell, where the deprioritization of the first cell is based on the stored AS operation failure information.

In some examples of the method, apparatus, or non-transitory computer-readable medium described above, the failures in AS operations comprise consecutive failures. In some examples of the method, apparatus, or non-transitory computer-readable medium described above, deprioritizing the first cell comprises: barring the first cell from selection, reselection, or both.

Some examples of the method, apparatus, or non-transitory computer-readable medium described above may further include processes, features, means, or instructions for detecting the first cell and the second cell during an out-of-service (OOS) scan, where selecting the second cell is based on the OOS scan.

Some examples of the method, apparatus, or non-transitory computer-readable medium described above may further include processes, features, means, or instructions for resetting the number of failures in AS operations for the first cell based on the deprioritization of the first cell. Some examples of the method, apparatus, or non-transitory computer-readable medium described above may further include processes, features, means, or instructions for resetting the number of failures in AS operations for the first cell based on a time period between failures.

Some examples of the method, apparatus, or non-transitory computer-readable medium described above may further include processes, features, means, or instructions for determining that a reselection criterion for cell is not met based on the deprioritization of the first cell. Some examples of the method, apparatus, or non-transitory computer-readable medium described above may further include processes, features, means, or instructions for removing the first cell from a list of cells eligible for reselection based on the deprioritization of the first cell.

Some examples of the method, apparatus, or non-transitory computer-readable medium described above may further include processes, features, means, or instructions for determining that a number of deprioritized cells within a group of cells exceeds a deprioritization threshold, where the group of cells comprises a frequency, a public land mobile network (PLMN), or a tracking area. Some examples of the method, apparatus, or non-transitory computer-readable medium described above may further include processes, features, means, or instructions for barring the group of cells for reselection for a time period based on the determination that the number of deprioritized cells exceeds deprioritization threshold.

Some examples of the method, apparatus, or non-transitory computer-readable medium described above may further include processes, features, means, or instructions for detecting movement of a device. Some examples of the method, apparatus, or non-transitory computer-readable medium described above may further include processes, features, means, or instructions for reinstating the group of cells for reselection based on the detected movement.

### BRIEF DESCRIPTION OF THE DRAWINGS

FIG. 1 illustrates an example of a wireless communications system that supports cell avoidance associated with lower layer failures in accordance with aspects of the present disclosure;

FIG. 2 illustrates an example of a wireless communications system that supports cell avoidance associated with lower layer failures in accordance with aspects of the present disclosure;

FIG. 3 illustrates an example of a process flow in a system that supports cell avoidance associated with lower layer failures in accordance with aspects of the present disclosure;

FIGS. 4 through 6 show block diagrams of a wireless device or devices that support cell avoidance associated with lower layer failures in accordance with aspects of the present disclosure;

FIG. 7 illustrates a block diagram of a system including a UE that supports cell avoidance associated with lower layer failures in accordance with aspects of the present disclosure; and

FIGS. 8 through 12 illustrate methods for cell avoidance associated with lower layer failures in accordance with aspects of the present disclosure.

### DETAILED DESCRIPTION

When a user equipment (UE) performs cell selection or reselection procedures (e.g., an attach procedure, a tracking area update (TAU) request, service request, etc.), it may encounter a lower layer failure, such as an error at the access stratum (AS) of a protocol stack. A lower layer failure may be caused by different factors, including frequency or timing offsets or a carrier to interference ratio that results in cyclic redundancy check (CRC) failures. These lower layer failures may lead to decoding errors in higher layers of a protocol stack. If a UE continues to select an unsuitable cell based on the selection criteria, it may repeatedly experience failures which could be avoided if the UE attempted to select a different cell.

Lower layer failures may include the expiration of a timer that begins after transmitting a radio resource control (RRC) connection request message, which may result in a failure to establish the RRC connection. Lower layer failures may also include read failures on a non-essential system information block (SIB). Lower layers, as used herein, may also refer to the physical layer and the data link layer of a protocol stack. As a result of a lower layer failure, a functional layer of a protocol stack (e.g., a non-access stratum (NAS) layer) may re-attempt the cell selection procedure.

According to the present disclosure, a UE may increment a counter on each failure, and may then modify the cell selection process (e.g., based on the number or type of failures). For example, the UE may alter the ranking of cells based on repeatedly experiencing lower layer failures. That is, upon recognizing a number of lower layer failures, the UE may find a suitable alternate cell by deprioritizing cells that are associated with lower layer failures. Thus, alternate cells may be made available even when they would not otherwise be treated with higher priority according to wireless communication systems that do not use cell deprioritization. In some cases, cell deprioritization may be used for cell reselection evaluation and not for cell selection.

The amount of time that a cell, frequency, or network is deprioritized may be a function of the number of failures on that cell in a short-term, medium-term, or long-term timeframe. The duration for deprioritization may also be based on the severity of the lower layer failure. In some cases, medium and longer-term failures may be determined based on statistics collected over a certain time period or via shared failure information. This process, which may be referred to as UE-fingerprinting, may include storing information related to historic events (e.g., previous failures) that the UE has experienced.

In some cases, a UE may deprioritize different cells according to the failure information associated with those cells. For example, the UE may determine chronic lower layer failures on a cell (e.g., after camping on that cell) and then identify alternate cells available in that location which provide an improved connection ability. This identification may be made based on fingerprinted information for the alternate cells. Additionally or alternatively, the UE may learn via crowd-sourced information that under certain reference signal received power (RSRP) regimes, specific cell global identities (CGIs) are known to experience random access channel (RACH) failures. The UE may also determine that lower layer failures arise more often during specific time periods for a cell (e.g., due to cell loading conditions) and deprioritize the cell accordingly. In some cases, the UE may bar selection or reselection procedures for a cell or a group of cells. During the time period during which selection or reselection procedures are barred, the UE may treat problematic cells as unavailable for idle mode operations irrespective of selection criteria that may otherwise be used for selecting the cell.

Aspects of the disclosure introduced above are next described in the context of a wireless communication system. An example of a failure based cell avoidance process is then described. Aspects of the disclosure are further illustrated by and described with reference to apparatus diagrams, system diagrams, and flowcharts that relate to cell avoidance associated with lower layer failures.

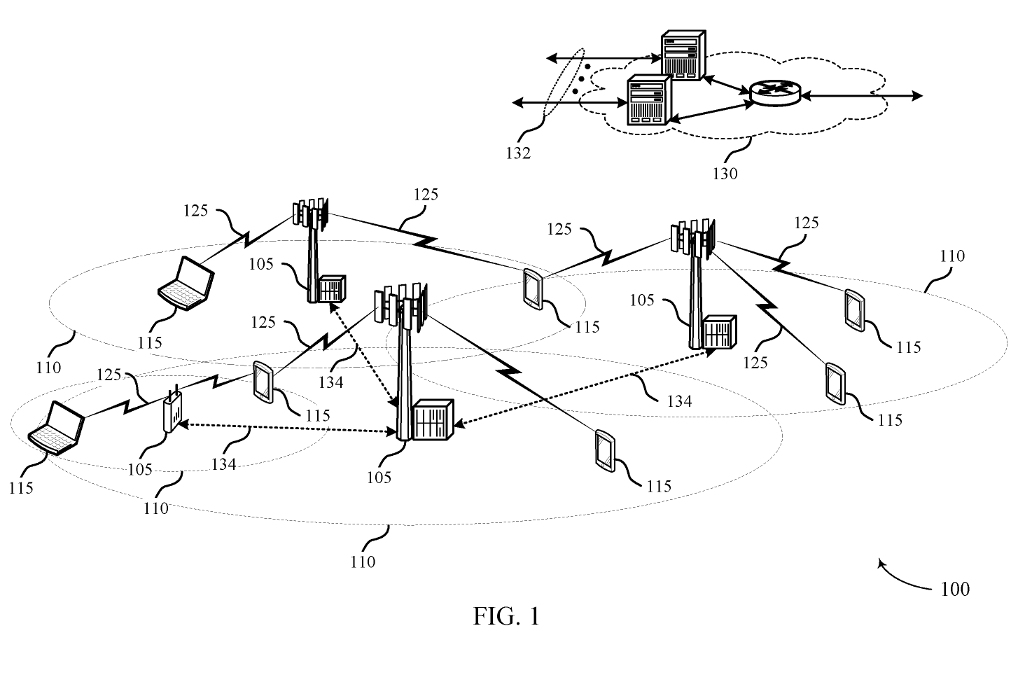

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. Wireless communications system 100 may support lower layer failure based cell avoidance procedures.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105. Communications between a base station 105 and a UE 115 for the purpose of establishing or maintaining the wireless link may be known as AS communications, while communications originating at the core network 130 may be known as NAS communications.

A UE 115 may perform a cell selection procedure to establish a connection with a base station 105 or to reselect a neighboring cell of the same or another base station 105 with better performance or higher priority. The selection procedure may include a determination of whether a candidate cell meets minimum selection criteria (S-criteria) or reselection criteria (R-criteria) and to select among several available cells. S-criteria or R-criteria may include

RSRP or reference signal received quality (RSRQ) , a minimum signal power threshold, a public land mobile network (PLMN) priority offset, a maximum transmit power, and a hysteresis parameter (e.g., to avoid ping-ponging between cells). Each cell may transmit its own minimum RSRP, cell priority, and maximum transmit power over system information block 1 (SIB1), and may convey corresponding values for neighboring cells in SIB4 and SIB5.

A UE 115 may begin a cell selection or reselection procedure by identifying a set of available PLMNs, selecting the highest priority PLMN (e.g., the home PLMN), and then selecting the best available cell in the selected PLMN. If a UE 115 is camped on a cell, it may periodically perform a cell search and rank available cells based on the S-criteria. If the UE 115 determines that a non-serving neighbor cell has qualifying S-criteria (i.e., the signal strength is sufficiently high), and the rank of the neighbor cell is higher than the rank of the serving cell, then the UE 115 may reselect to the higher rank cell. If the UE 115 performs the cell search while connected to a visitor public land mobile network (VPLMN), it may use the priority offset to give preference to a home PLMN (or another higher priority PLMN).

After cells have been prioritized based on S-criteria or R-criteria, a UE 115 may attempt to establish a connection with the highest ranked cell. The UE 115 may begin by attempting to decode a master information block (MIB) and one or more system information blocks (SIBs) periodically transmitted by the cell. After the UE 115 decodes the MIB, SIB1, and SIB2, it may transmit a RACH preamble to a base station 105. This may be known as RACH message 1. For example, the RACH preamble may be randomly selected from a set of 64 predetermined sequences. This may enable the base station 105 to distinguish between multiple UEs 115 trying to access the system simultaneously. The base station 105 may respond with a random access response (RAR), or RACH message 2, that provides an UL resource grant, a timing advance and a cell radio network temporary identity (C-RNTI). The UE 115 may then transmit an RRC connection request, or RACH message 3, along with a temporary mobile subscriber identity (TMSI) (e.g., if the UE 115 has previously been connected to the same wireless network) or a random identifier.

The RRC connection request may also indicate the reason the UE 115 is connecting to the network (e.g., emergency, signaling, data exchange, etc.). The base station 105 may respond to the connection request with a contention resolution message, or RACH message 4, addressed to the UE 115, which may provide a new C-RNTI. If the UE 115 receives a contention resolution message with the correct identification (ID), it may proceed with RRC setup. If the UE 115 does not receive a contention resolution message (e.g., if there is a conflict with another UE 115) it may repeat the RACH process by transmitting a new RACH preamble. If a number of RACH processes (or other AS procedures) fail, a UE 115 may deprioritize a cell so that it may attempt to connect to a more suitable cell.

As described herein, a UE 115 may determine that a number of AS operations or communications have failed while attempting to communicate with a cell (e.g., a serving cell). Based on the AS failures, the UE 115 may deprioritize the cell. Based on the deprioritization, the UE 115 may then attempt to select or reselect a different cell even if the serving cell is ranked higher based on a selection criteria or reselection criteria ranking of candidates. In some cases, UEs 115 may store and share historical AS failure information that may also be used to determine when to deprioritize a cell. In some cases, a group of cells may be deprioritized (e.g., a group based on frequency, network, or tracking area).

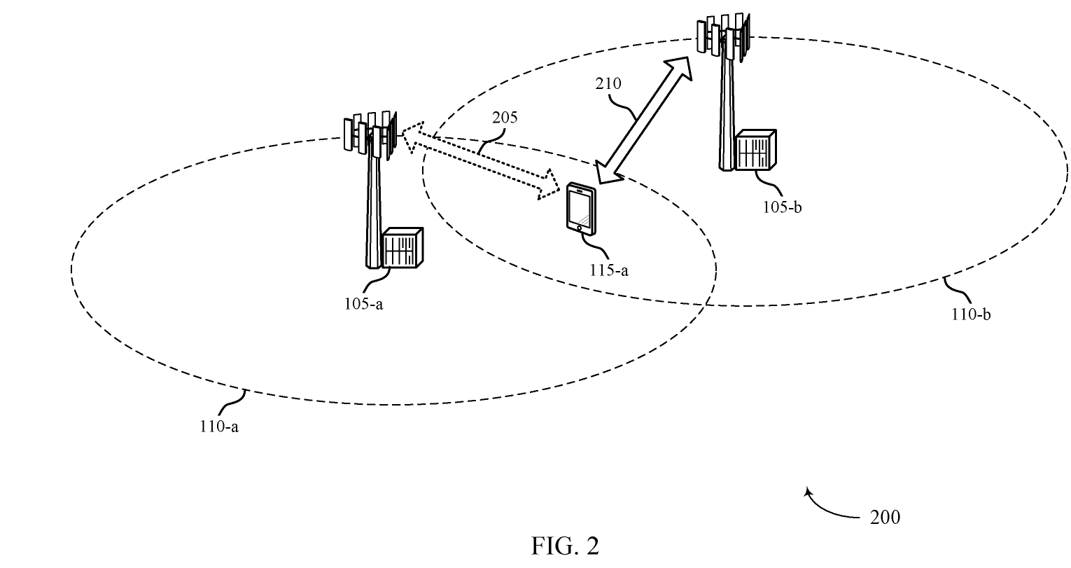

FIG. 2 illustrates an example of a wireless communications system 200 for cell avoidance associated with lower layer failures. Wireless communications system 200 may include base stations 105-a and 105-b, in addition to UE 115-a, which may be examples of the corresponding devices described with reference to FIG. 1. Wireless communications system 200 may support lower layer failure based cell avoidance procedures. For example, UE 115-a may experience lower layer failures while attempting to communicate with base station 105-a over communications link 205, and may then select base station 105-b and communicate over communications link 210. In some cases, more than one different cell associated with lower layer failure-based cell avoidance procedures may be supported by a single base station (e.g., base station 105-a).

That is, when UE 115-a performs cell selection or reselection procedures with base station 105-a (e.g., an attach procedure, a TAU request, service request, etc.) on a cell of base station 105-a, UE 115-a may encounter a lower layer failure, such as an error at the AS of a protocol stack. A lower layer failure may be caused by different factors, such as frequency or timing offsets or a carrier to interference ratio that results in CRC failures. These lower layer failures may lead to decoding errors in higher layers of a protocol stack. Lower layer failures may include the expiration of a timer that begins after transmitting a RRC connection request message (e.g., a T300 timer), which may result in a failure to establish the RRC connection. Lower layer failures may also include read (e.g., decode) failures on a non-essential SIB.

As a result of a lower layer failure, a functional layer of a protocol stack (e.g., a NAS layer) may re-attempt the cell selection procedure. For example, when an attach or TAU request is sent, UE 115-a may re-attempt the procedure after the expiration of a timer (e.g., following the expiration of a T3411 timer). In other examples, when sending a service request, UE 115-a may re-attempt the selection procedure based on a subsequent trigger from an upper layer, which may, for example, depend on whether the attempt is for a packet data network (PDN) connectivity request or for user data transmission.

When lower layer failures take place, a selection procedure attempt counter may increment on each failure. For example, absent the techniques described herein, when an attach or TAU request attempt counter increments to a certain value (e.g., 5 failures), UE 115-a may run a timer for a certain duration (e.g., a T3402 timer for 12 minutes) and bar a cell, such as a PLMN cell, for the duration of the timer. In some examples, when a service request attempt counter increments to a certain value, further service request procedures may be throttled for a certain amount of time (e.g. 1 minute). In these cases, if UE 115-a is on a cell where repeated lower layer failures occur, in the absence of the deprioritization procedures described herein, there may be no procedures to avoid camping on that cell.

Thus, UE 115-a may use a cell deprioritization-based approach to cell selection. For example, UE 115-a may alter the ranking of available cells based on lower layer failures. That is, following a number of lower layer failures, such as AS operation failures, UE 115-a can find a suitable alternate cell by deprioritizing cells that are associated with the lower layer failures. UE 115-a may find a suitable alternate cell upon repeated access stratum failures (e.g., RACH, T300 expiration, RRC connection rejections, SIB decodes in cells, etc.) or the expiration of NAS procedure timers (e.g., T3410/T3417/T3430 timers, etc.), which may also be referred to as evolved packet system (EPS) mobility management (EMM) timers. As an example, the deprioritization of cells may be done by decreasing the rank of deprioritized cells for a period of time (e.g., T_{rcc} seconds) to provide an opportunity for alternate cells to be treated with higher priority. Thus, these alternate cells may be made available even when they would not otherwise be treated with higher priority according to wireless communication systems that do not use techniques described herein. In some cases, cell deprioritization may only be used for cell reselection evaluation and not for cell selection.

In some cases, the amount of time (i.e., duration) that a cell (or group of cells), frequency, or a network employing a given radio access technology (RAT) is deprioritized may be a function of the number of failures on that cell (or group of cells) in a short-term, medium-term, and long-term timeframe or time period. Similarly, the duration that a cell, frequency, or a network employing a given RAT is barred may be a function of the number of failures on that cell. The duration for deprioritization or barring may also be based on the severity of the lower layer failure. That is, deprioritization timer parameters may vary depending on the time horizon or on severity of lower layer failure. For example, a deprioritization timer may be relatively long for cells that are associated with chronic problems. In some cases, medium and longer-term failures may be determined based on statistics collected over a certain time period (e.g., hours, days, weeks, etc.), via crowd-sourced methods (e.g., a UE fingerprint). UE-fingerprinting may include storing information related to historic events that UE 115-a has experienced. For instance, UE 115-a may frequently camp on a cell near a user's home and may develop and store UE-specific data related to that cell.

In some cases, UE 115-a may deprioritize different cells of base station 105-a or 105-b according to the failure information associated with those cells. For example, UE 115-a may determine chronic lower layer failures on a cell (e.g., after camping on that cell) and then identify alternate cells available in that location which provide an improved connection ability. This identification may be made based on fingerprinted information for the alternate cells. Additionally or alternatively, UE 115-a may learn via crowd-sourced information that under certain RSRP regimes, specific CGIs are known to experience RACH failures. UE 115-a may also determine that lower layer failures arise more often during specific time periods for a cell (e.g., due to cell loading conditions) and deprioritize those cells accordingly. In some cases, UE 115-a may bar selection or reselection procedures for such cells for a certain time period after determining that a number of lower layer failures have occurred. During the time period during which selection or reselection procedures are barred, UE 115-a may treat problematic cells as unavailable for idle mode operations irrespective of selection criteria that may otherwise be used for selecting the cell.

UE 115-a may implement a deprioritization trigger that allows it to deprioritize a cell upon a number of consecutive lower layer failures. The cell may be identified by a CGI, an evolved UMTS terrestrial radio access (EUTRA) absolute radio-frequency channel number (EARFCN), a physical cell identifier (PCI), or the like, and may be deprioritized for the duration of the deprioritization timer (where the deprioritization timer is applied per-cell).

Similarly, an un-deprioritization trigger (i.e., a trigger to remove deprioritization) may be used once the deprioritization timer expires or is stopped for a cell. In some cases, the deprioritization timer may be stopped for an identified cell when a base station performs a handover to this cell, such as when in RRC_CONNECTED mode. In some cases, the number may be reset (i.e., set to zero) for a specific identified cell if the deprioritization timer is started for a PCI, or if the gap between consecutive failures is greater than the duration of a different timer (e.g., a timer T_{gap} greater than 60 seconds).

For intra-frequency and equal priority inter-frequency cell reselection processes, when the deprioritization timer is running for an identified cell, UE 115-a may rank non-deprioritized cells over deprioritized cells based on frequency. Additionally or alternatively, UE 115-a may prioritize non-deprioritized cells in other frequencies over deprioritized cells in a serving frequency (and cells in its equal priority frequencies). Such procedures may be used in lieu of (or in addition to) rules or criteria that typically govern reselection in the system (e.g., ranking according to S-criteria).

For inter-frequency and non-equal priority inter-frequency cell reselection procedures, UE 115-a may be camped on a non-deprioritized cell while the deprioritization timer is running. When identifying a cell on the target inter-frequency, UE 115-a may determine that a threshold for cell selection criteria (e.g., Sᵣₓₗₑᵥ/S_{qual}) may be met, but UE 115-a may behave as if the selection criteria condition is not met and follow reselection procedures associated with systems that do not use deprioritization with the above correction. Such procedures may be used in lieu of (or in addition to) rules or criteria that typically govern reselection in the system. In some examples, UE 115-a may perform inter-RAT measurements (e.g., wideband code division multiple access (WCDMA) to LTE inter-RAT measurements) when camped on a cell associated with a first RAT (e.g., WCDMA) that is not deprioritized. If a deprioritized cell meets threshold criteria for cell reselection, then UE 115-a may exclude these cells from the list of cells eligible for reselection.

In some cases, if all or a significant number of cells associated with a given frequency are deprioritized, UE 115-a may bar the frequency for a duration of time. This may allow UE 115-a to camp on a lower priority cell (e.g, of base station 105-b) instead of camping on a higher priority cell (e.g., of base station 105-a) where service is not possible due to lower layer failures. Additionally, based on mobility detection (which may be determined using inertial sensors, such as accelerometers, pedometers, etc.), UE 115-a may un-bar the frequency in the case where UE 115-a finds coverage in a different cell. In some cases, UE 115-a may deprioritize a group of cells (such as a PLMN or tracking area (TA)) for a certain duration of time. Additionally or alternatively, UE 115-a may consider a network as deprioritized to enable it to move to a different network.

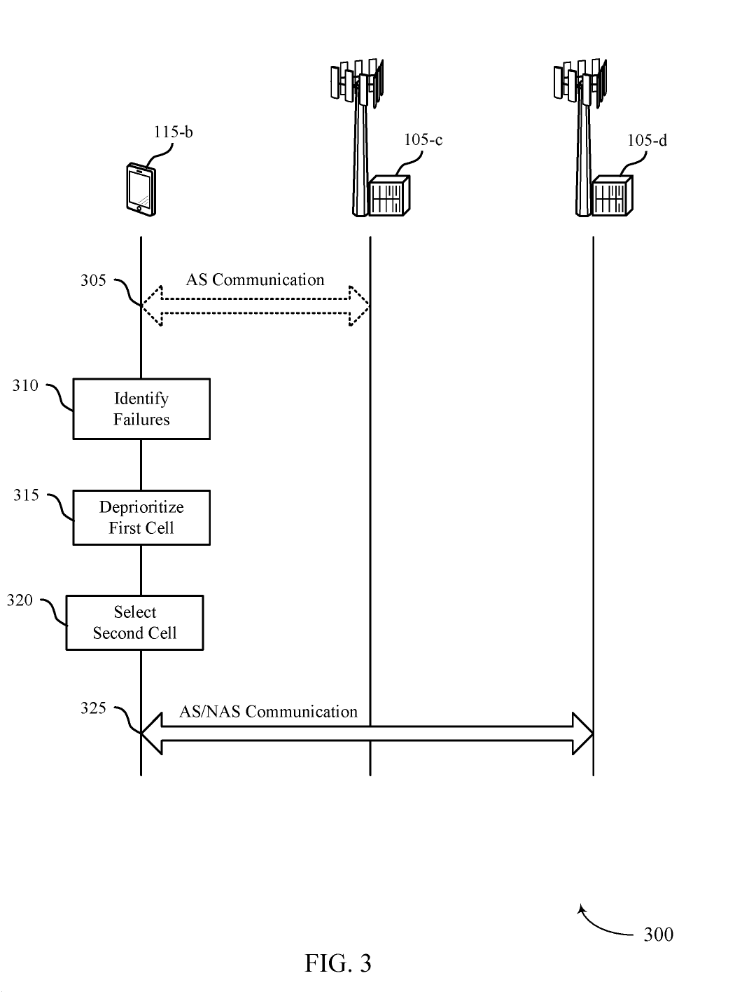

FIG. 3 illustrates an example of a process flow 300 for cell avoidance associated with lower layer failures in accordance with various aspects of the present disclosure. Process flow 300 may include base stations 105-c and 105-d and UE 115-b, which may be examples of the corresponding devices described with reference to FIG. 1-2.

At step 305, UE 115-b may attempt to communicate with base station 105-c. However, the communications (or the attempt to connect, or other AS procedures) may fail. For example, UE 115-b may repeatedly attempt to connect to base station 105-c if a cell of base station 105-c is a highest ranked cell according a S-criteria or R-criteria.

At step 310, UE 115-b may identify the failures and may determine that the number of failures exceeds a threshold. In some cases, the failures may occur within a designated time period, and if the gap between failures is great enough, a failure counter may be reset.

At step 315, UE 115-b may deprioritize the first cell (i.e., the cell from base station 105-c) relative to a priority of a second cell. In some cases, the cell may be deprioritized (or barred) for selection, reselection, or out-of-service (OOS) scanning for a certain time period, after which the cell may be reprioritized. In some cases, the deprioritization may be based on stored or crowd-sourced information about the cell. Thus, UE 115-b may identify a cell ranking based on S-criteria or R-criteria and then perform an additional independent prioritization based on lower layer failures. Thus, in some cases, a deprioritized cell may still be the highest ranked cell in the S-criteria ranking.

At step 320, UE 115-b may select the second cell (i.e., a different cell supported by base station 105-d). In some cases (not shown) the second cell may be supported by the same base station (i.e., on a different frequency). In some cases, UE 115-b may select the second cell as part of a selection, a reselection, or a OOS scanning operation.

At step 325, UE 115-c may establish (or attempt to establish) a connection and wirelessly communicate with the second cell (i.e., the cell supported by base station 105-d). After a time period has passed, a UE 115-c has moved locations or performed a mobility operation (e.g., a handover) to another cell, etc., UE 115-c may reprioritize (i.e., un-deprioritize or unbar) the first cell.

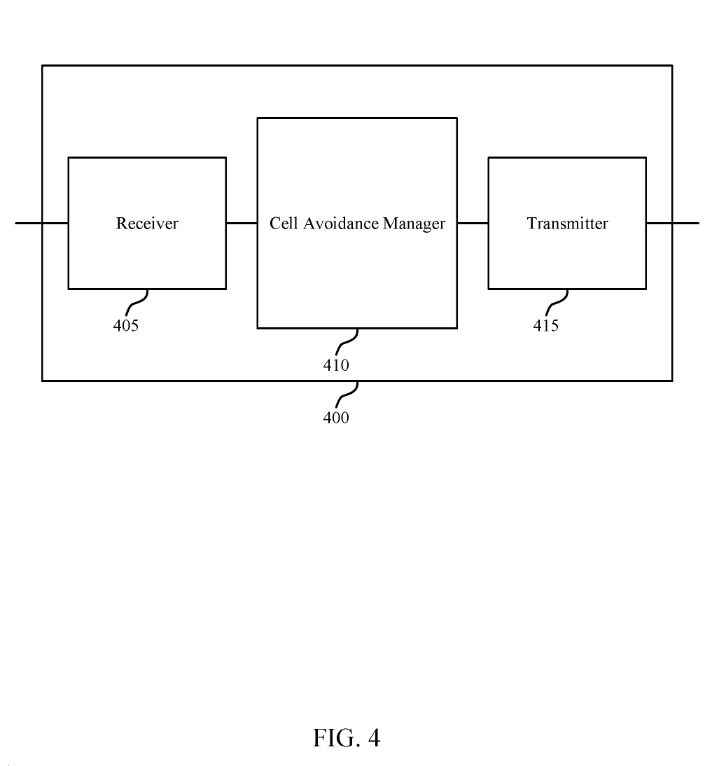

FIG. 4 shows a block diagram of a wireless device 400 that supports cell avoidance associated with lower layer failures in accordance with various aspects of the present disclosure. Wireless device 400 may be an example of aspects of a UE 115 described with reference to FIGS. 1, 2, and 3. Wireless device 400 may include receiver 405, cell avoidance manager 410 and transmitter 415. Wireless device 400 may also include a processor. Each of these components may be in communication with one another.

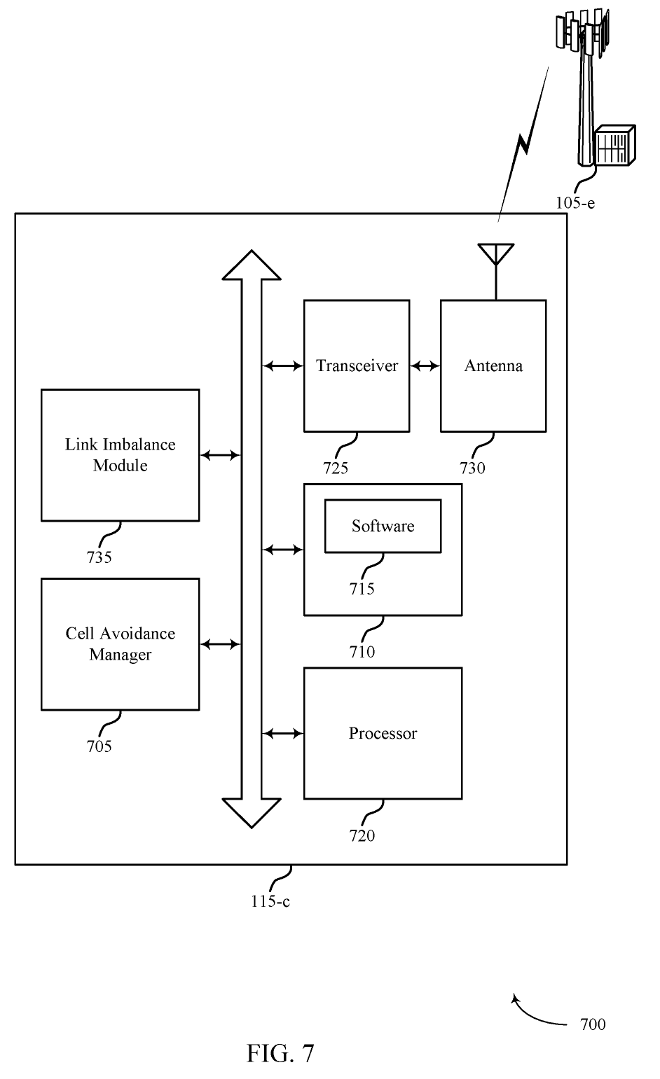

The receiver 405 may receive information such as packets, user data, or control information associated with various information channels (e.g., control channels, data channels, information related to cell avoidance associated with lower layer failures, etc.). Information may be passed on to other components of the device. The receiver 405 may be an example of aspects of the transceiver 725 described with reference to FIG. 7. The receiver 405 may include a single antenna, or it may include a plurality of antennas.

The cell avoidance manager 410 may determine that a number of failures in AS operations for a first cell has exceeded a threshold, deprioritize the first cell relative to a priority of a second cell based on the determination that the number of failures has exceeded the threshold, select the second cell based on the deprioritization of the first cell, and communicate with the second cell based at least in part on selecting the second cell. The cell avoidance manager 410 may also be an example of aspects of the cell avoidance manager 705 described with reference to FIG. 7.

The transmitter 415 may transmit signals received from other components of wireless device 400. In some examples, the transmitter 415 may be collocated with a receiver in a transceiver module. For example, the transmitter 415 may be an example of aspects of the transceiver 725 described with reference to FIG. 7. The transmitter 415 may include a single antenna, or it may include a plurality of antennas.

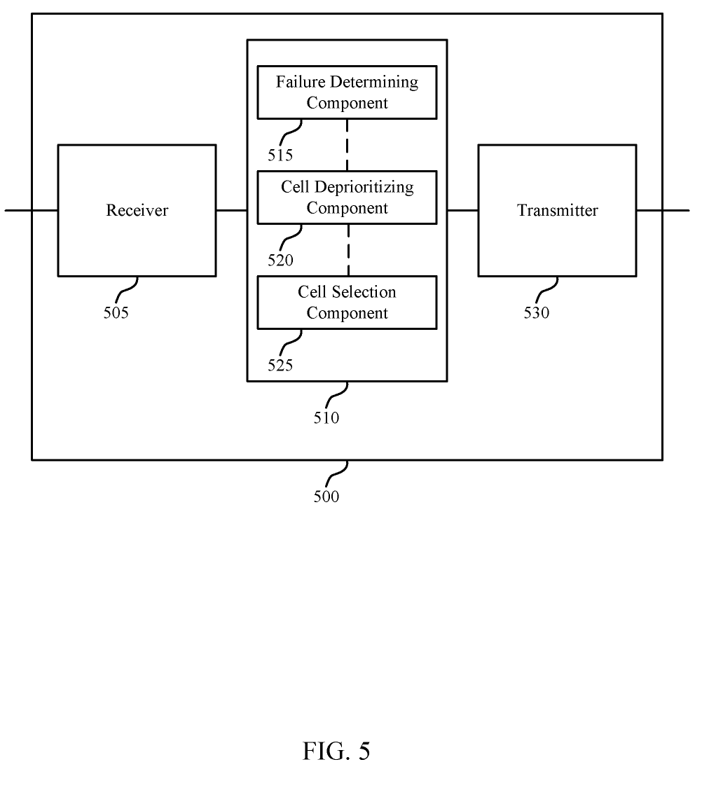

FIG. 5 shows a block diagram of a wireless device 500 that supports cell avoidance associated with lower layer failures in accordance with various aspects of the present disclosure. Wireless device 500 may be an example of aspects of a wireless device 400 or a UE 115 described with reference to FIGS. 1-4. Wireless device 500 may include receiver 505, cell avoidance manager 510, and transmitter 530. Wireless device 500 may also include a processor. Each of these components may be in communication with one another.

The receiver 505 may receive information which may be passed on to other components of the device. The receiver 505 may also perform the functions described with reference to the receiver 405 of FIG. 4. The receiver 505 may be an example of aspects of the transceiver 725 described with reference to FIG. 7.

The cell avoidance manager 510 may be an example of aspects of cell avoidance manager 410 described with reference to FIG. 4. The cell avoidance manager 510 may include failure determining component 515, cell deprioritizing component 520, and cell selection component 525. The cell avoidance manager 510 may be an example of aspects of the cell avoidance manager 705 described with reference to FIG. 7.

The failure determining component 515 may reset the number of failures in AS operations for the first cell based on the deprioritization of the first cell, reset the number of failures in AS operations for the first cell based on a time period between failures, and/or determine that a number of failures in AS operations for a first cell has exceeded a threshold. In some cases, the failures in AS operations include a random access operation failure, a RRC connection attempt failure, an expiry of an RRC connection timer, a SIB decode failure, or a combination thereof. In some cases, the failures in AS operations include consecutive failures.

The cell deprioritizing component 520 may deprioritize the first cell based on the determination that the number of failures has exceeded the threshold. Additionally or alternatively, the cell deprioritizing component 520 may determine that the duration of the deprioritization has passed and reprioritize the first cell cased at least in part on the determination that the duration has passed. In some cases, the first cell may be deprioritized by reducing a priority level of the first cell relative to a priority of the second cell. In some cases, a set of non-deprioritized cells may be ranked over a set of deprioritized cells on a same frequency; the set of non-deprioritized cells may include the second cell, and the set of deprioritized cells may include the first cell.

In some cases, a set of non-deprioritized cells may be prioritized over a set of deprioritized cells on a different frequency; the set of non-deprioritized cells may include the second cell, and the set of deprioritized cells may include the first cell. In some cases, a duration of the deprioritization of the first cell may be based on the number of failures in AS operations exceeding the threshold within a designated time period. In some cases, the designated time period is an hour, a day, or a week, or a combination thereof. In some cases, the determination that the duration for the deprioritization has passed is based on an RRC connected mode mobility operation to the first cell. In some cases, a duration of the deprioritization of the first cell is based on a type of AS operations that have failed in excess of the threshold. In some cases, deprioritizing the first cell includes barring the first cell from selection, reselection, or both.

The cell selection component 525 may select a second cell based on the deprioritization of the first cell. In some cases, selecting the second cell may be a part of a selection, reselection, or OOS scanning procedure. The transmitter 530 may transmit signals received from other components of wireless device 500. In some examples, the transmitter 530 may be collocated with a receiver in a transceiver module. For example, the transmitter 530 may be an example of aspects of the transceiver 725 described with reference to FIG. 7. The transmitter 530 may utilize a single antenna, or it may utilize a plurality of antennas.

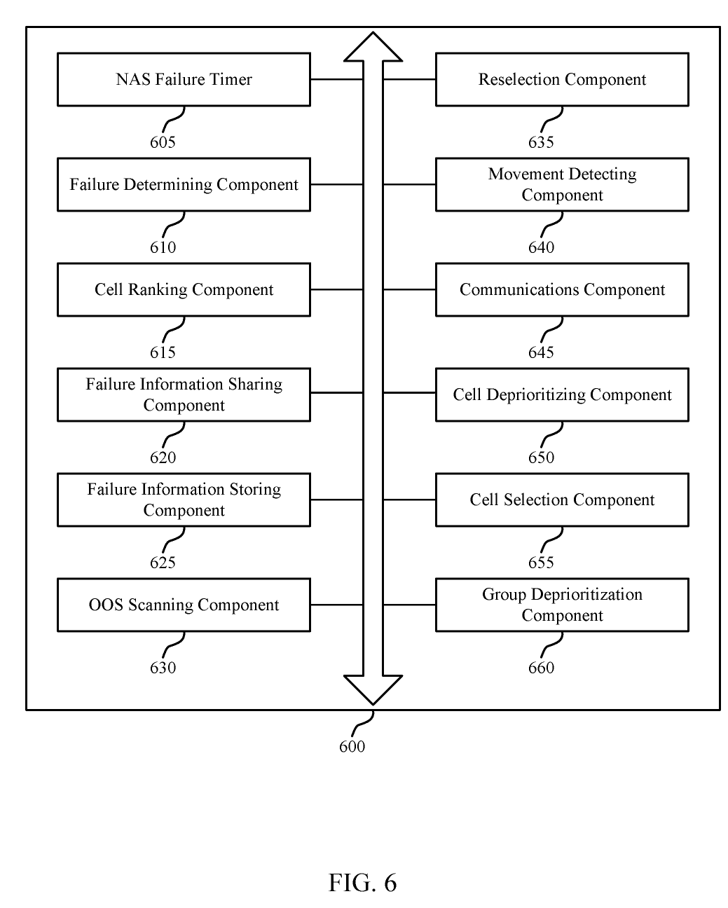

FIG. 6 shows a block diagram of a cell avoidance manager 600 which may be an example of the corresponding component of wireless device 400 or wireless device 500. That is, cell avoidance manager 600 may be an example of aspects of cell avoidance manager 410 or cell avoidance manager 510 described with reference to FIGS. 4 and 5. The cell avoidance manager 600 may also be an example of aspects of the cell avoidance manager 705 described with reference to FIG. 7.

The cell avoidance manager 600 may include NAS failure timer 605, failure determining component 610, cell ranking component 615, failure information sharing component 620, failure information storing component 625, OOS scanning component 630, reselection component 635, movement detecting component 640, communications component 645, cell deprioritizing component 650, cell selection component 655 and group deprioritization component 660. Each of these modules may communicate, directly or indirectly, with one another (e.g., via one or more buses).

The NAS failure timer 605 may determine that a timer associated with a NAS procedure has expired, where the deprioritization of the first cell is based on the expiration of the timer associated with the NAS procedure. In some cases, the timer associated with the NAS procedure includes an evolved packet system (EPS) mobility management (EMM) timer. The failure determining component 610 may reset the number of failures in AS operations for the first cell based on the deprioritization of the first cell, reset the number of failures in AS operations for the first cell based on a time period between failures, and determine that a number of failures in AS operations for a first cell has exceeded a threshold.

The cell ranking component 615 may rank the first cell among a set of deprioritized cells based on the number of failures in AS operations for the first cell. The failure information sharing component 620 may receive AS operation failure information associated with at least one other UE at the first cell, where the deprioritization of the first cell is based on the received AS operation failure information.

The failure information storing component 625 may store AS operation failure information for the first cell, where the deprioritization of the first cell is based on the stored AS operation failure information. The OOS scanning component 630 may detect the first cell and the second cell during an OOS scan, where selecting the second cell is based on the OOS scan. The reselection component 635 may determine that a reselection criterion for a cell is not met based on the deprioritization of the first cell, and remove the first cell from a list of cells eligible for reselection based on the deprioritization of the first cell. The movement detecting component 640 may detect movement of a device (e.g., based on a Doppler measurement, a global positioning system (GPS) measurement, an accelerometer measurement, etc.). The communications component 645 may communicate with the second cell based on selecting the second cell.

The cell deprioritizing component 650 may deprioritize the first cell based on the determination that the number of failures has exceeded the threshold. Additionally or alternatively, the cell avoidance manager 600 may determine that the duration of the deprioritization has passed and reprioritize the first cell cased at least in part on the determination that the duration has passed. The cell selection component 655 may select a second cell based on the deprioritization of the first cell. The group deprioritization component 660 may determine that a number of deprioritized cells within a group of cells exceeds a deprioritization threshold, where the group of cells includes a frequency, a PLMN, or a tracking area, bar the group of cells for reselection for a time period based on the determination that the number of deprioritized cells exceeds the deprioritization threshold, and reinstate the group of cells for reselection based on the detected movement.

FIG. 7 shows a diagram of a system 700 including a device that supports cell avoidance associated with lower layer failures in accordance with various aspects of the present disclosure. For example, system 700 may include UE 115-c, which may be an example of a wireless device 400, a wireless device 500, or a UE 115 as described with reference to FIGS. 1 through 6.

UE 115-c may also include cell avoidance manager 705, memory 710, processor 720, transceiver 725, antenna 730, and link imbalance module 735. Each of these modules may communicate, directly or indirectly, with one another (e.g., via one or more buses). The cell avoidance manager 705 may be an example of a cell avoidance manager as described with reference to FIGS. 4 through 6.

The memory 710 may include random access memory (RAM) and read only memory (ROM). The memory 710 may store computer-readable, computer-executable software including instructions that, when executed, cause the processor to perform various functions described herein (e.g., cell avoidance associated with lower layer failures, etc.). In some cases, the software 715 may not be directly executable by the processor but may cause a computer (e.g., when compiled and executed) to perform functions described herein. The processor 720 may include an intelligent hardware device, (e.g., a central processing unit (CPU), a microcontroller, an application specific integrated circuit (ASIC), etc.).

The transceiver 725 may communicate bi-directionally, via one or more antennas, wired, or wireless links, with one or more networks, as described above. For example, the transceiver 725 may communicate bi-directionally with a base station 105 or a UE 115. The transceiver 725 may also include a modem to modulate the packets and provide the modulated packets to the antennas for transmission, and to demodulate packets received from the antennas. In some cases, the wireless device may include a single antenna 730. However, in some cases the device may have more than one antenna 730, which may be capable of concurrently transmitting or receiving multiple wireless transmissions.

The link imbalance module 735 may determine that a link condition exists that may contribute to lower layer failures. For example, the link imbalance module 735 may identify an asymmetry in uplink and downlink conditions or signal strengths that may be prone to AS operation failures. In some cases, the link imbalance module 735 may identify particular geographic regions, networks, or the like that are prone to such failures. The link imbalance module 735 may thus support a determination that a number of AS operation failures has or is likely to exceed a threshold. In some cases, the link imbalance module 735 may contribute data or stored information to UE-fingerprinting as described above.

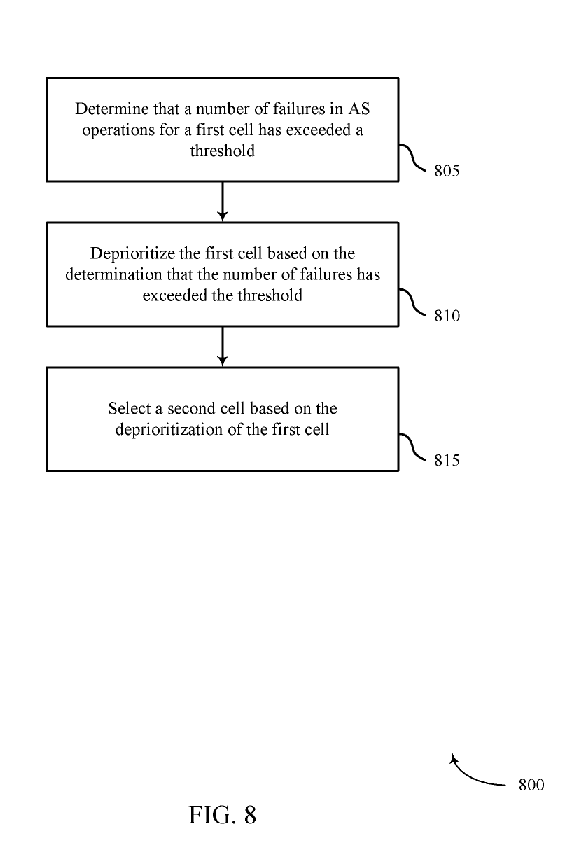

FIG. 8 shows a flowchart illustrating a method 800 for cell avoidance associated with lower layer failures in accordance with various aspects of the present disclosure. The operations of method 800 may be implemented by a device such as a UE 115 or its components as described above. For example, the operations of method 800 may be performed by the cell avoidance manager as described herein. In some examples, the UE 115 may execute a set of codes to control the functional elements of the device to perform the functions described below. Additionally or alternatively, the UE 115 may perform aspects of the functions described below using special-purpose hardware.

At block 805, the UE 115 may determine that a number of failures in AS operations for a first cell has exceeded a threshold as described above with reference to FIGS. 2 and 3. In certain examples, the operations of block 805 may be performed by the failure determining component as described with reference to FIGS. 5 and 6.

At block 810, the UE 115 may deprioritize the first cell based on the determination that the number of failures has exceeded the threshold as described above with reference to FIGS. 2 and 3. In certain examples, the operations of block 810 may be performed by the cell deprioritizing component as described with reference to FIGS. 5 and 6.

At block 815, the UE 115 may select a second cell based on the deprioritization of the first cell as described above with reference to FIGS. 2 and 3. In certain examples, the operations of block 815 may be performed by the cell selection component as described with reference to FIGS. 5 and 6.

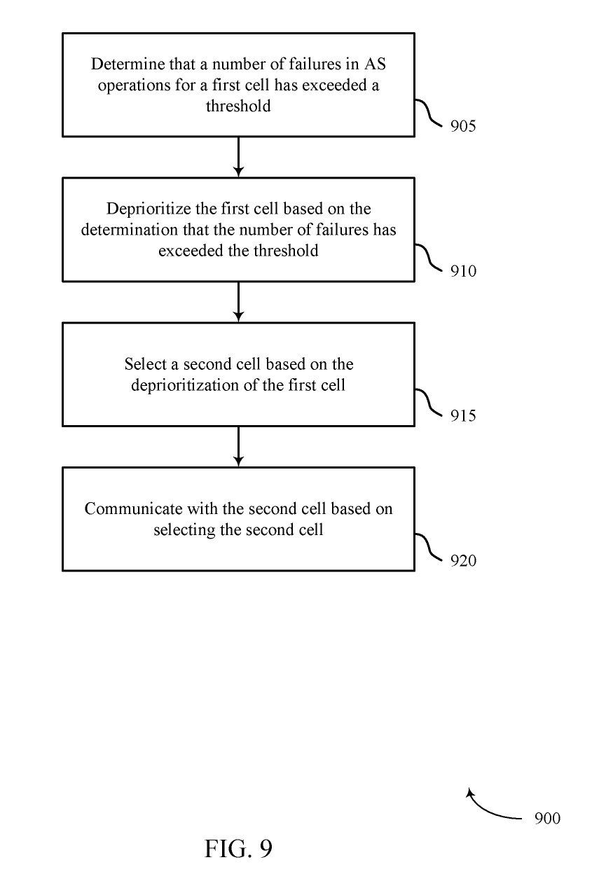

FIG. 9 shows a flowchart illustrating a method 900 for cell avoidance associated with lower layer failures in accordance with various aspects of the present disclosure. The operations of method 900 may be implemented by a device such as a UE 115 or its components as described above. For example, the operations of method 900 may be performed by the cell avoidance manager as described herein. In some examples, the UE 115 may execute a set of codes to control the functional elements of the device to perform the functions described below. Additionally or alternatively, the UE 115 may perform aspects of the functions described below using special-purpose hardware.

At block 905, the UE 115 may determine that a number of failures in AS operations for a first cell has exceeded a threshold as described above with reference to FIGS. 2 and 3. In certain examples, the operations of block 905 may be performed by the failure determining component as described with reference to FIGS. 5 and 6.

At block 910, the UE 115 may deprioritize the first cell based on the determination that the number of failures has exceeded the threshold as described above with reference to FIGS. 2 and 3. In certain examples, the operations of block 910 may be performed by the cell deprioritizing component as described with reference to FIGS. 5 and 6.

At block 915, the UE 115 may select a second cell based on the deprioritization of the first cell as described above with reference to FIGS. 2 and 3. In certain examples, the operations of block 915 may be performed by the cell selection component as described with reference to FIGS. 5 and 6.

At block 920, the UE 115 may communicate with the second cell based on selecting the second cell as described above with reference to FIGS. 2 and 3. In certain examples, the operations of block 920 may be performed by the communications component as described with reference to FIGS. 5 and 6.

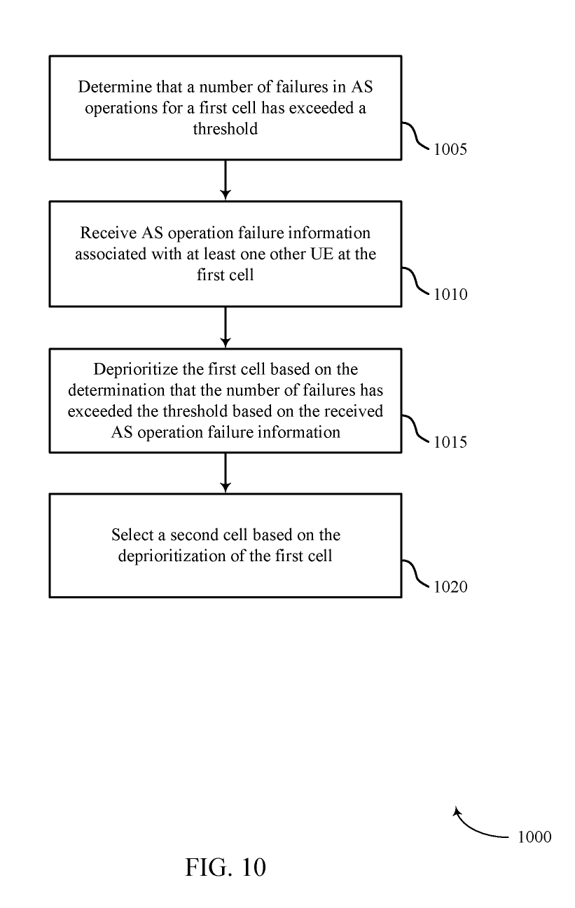

FIG. 10 shows a flowchart illustrating a method 1000 for cell avoidance associated with lower layer failures in accordance with various aspects of the present disclosure. The operations of method 1000 may be implemented by a device such as a UE 115 or its components as described above. For example, the operations of method 1000 may be performed by the cell avoidance manager as described herein. In some examples, the UE 115 may execute a set of codes to control the functional elements of the device to perform the functions described below. Additionally or alternatively, the UE 115 may perform aspects of the functions described below using special-purpose hardware.

At block 1005, the UE 115 may determine that a number of failures in AS operations for a first cell has exceeded a threshold as described above with reference to FIGS. 2 and 3. In certain examples, the operations of block 1005 may be performed by the failure determining component as described with reference to FIGS. 5 and 6.

At block 1010, the UE 115 may receive AS operation failure information associated with at least one other UE at the first cell as described above with reference to FIGS. 2 and 3. In certain examples, the operations of block 1010 may be performed by the failure information sharing component as described with reference to FIGS. 5 and 6.

At block 1015, the UE 115 may deprioritize the first cell based on the determination that the number of failures has exceeded the threshold as described above with reference to FIGS. 2 and 3. In some cases, the deprioritization of the first cell is based on the received AS operation failure information. In certain examples, the operations of block 1015 may be performed by the cell deprioritizing component as described with reference to FIGS. 5 and 6.

At block 1020, the UE 115 may select a second cell based on the deprioritization of the first cell as described above with reference to FIGS. 2 and 3. In certain examples, the operations of block 1020 may be performed by the cell selection component as described with reference to FIGS. 5 and 6.

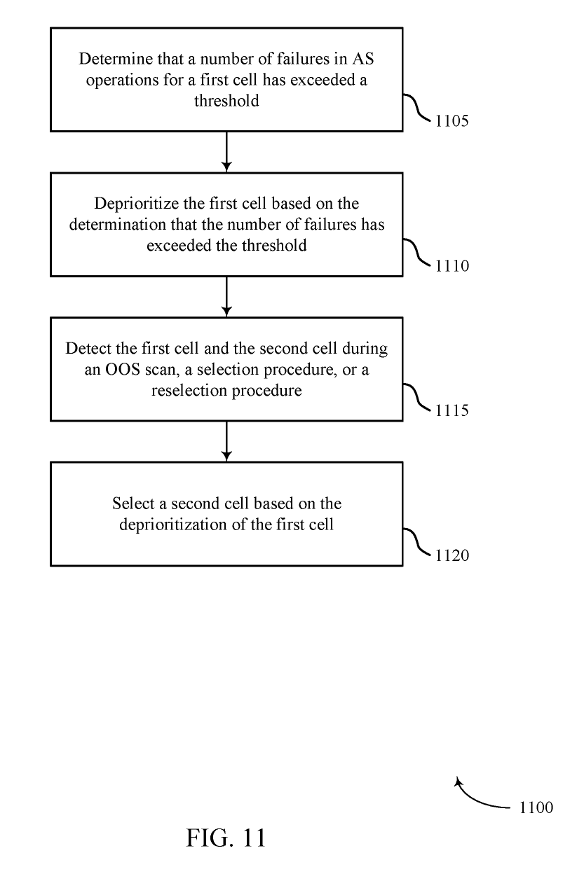

FIG. 11 shows a flowchart illustrating a method 1100 for cell avoidance associated with lower layer failures in accordance with various aspects of the present disclosure. The operations of method 1100 may be implemented by a device such as a UE 115 or its components as described above. For example, the operations of method 1100 may be performed by the cell avoidance manager as described herein. In some examples, the UE 115 may execute a set of codes to control the functional elements of the device to perform the functions described below. Additionally or alternatively, the UE 115 may perform aspects of the functions described below using special-purpose hardware.

At block 1105, the UE 115 may determine that a number of failures in AS operations for a first cell has exceeded a threshold as described above with reference to FIGS. 2 and 3. In certain examples, the operations of block 1105 may be performed by the failure determining component as described with reference to FIGS. 5 and 6.

At block 1110, the UE 115 may deprioritize the first cell based on the determination that the number of failures has exceeded the threshold as described above with reference to FIGS. 2 and 3. In certain examples, the operations of block 1110 may be performed by the cell deprioritizing component as described with reference to FIGS. 5 and 6.

At block 1115, the UE 115 may detect the first cell and the second cell during an OOS scan, a selection procedure, or a reselection procedure as described above with reference to FIGS. 2 and 3. In certain examples, the operations of block 1115 may be performed by the OOS scanning component as described with reference to FIGS. 5 and 6.

At block 1120, the UE 115 may select a second cell based on the deprioritization of the first cell as described above with reference to FIGS. 2 and 3. In some cases, selecting the second cell is based on the OOS scan, the selection procedure, or the reselection procedure. In certain examples, the operations of block 1120 may be performed by the cell selection component as described with reference to FIGS. 5 and 6.

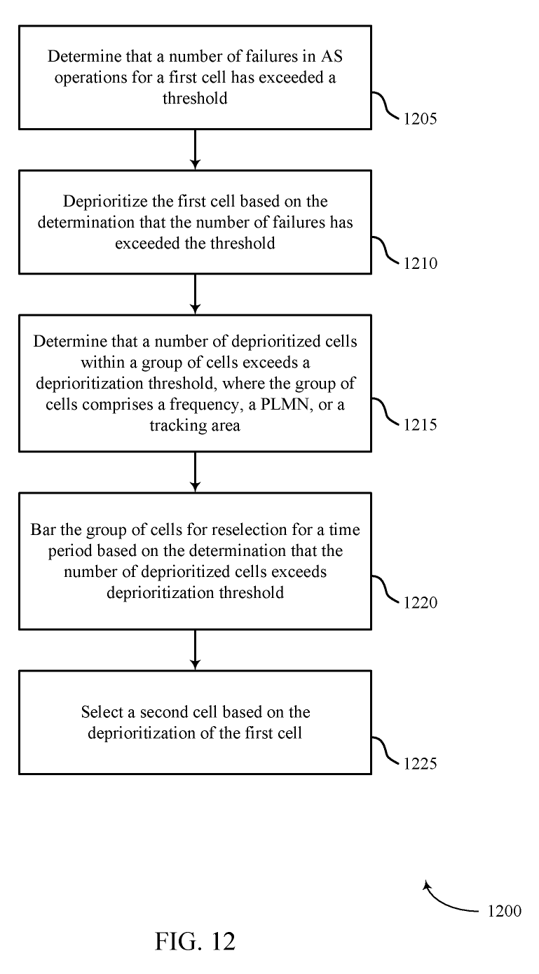

FIG. 12 shows a flowchart illustrating a method 1200 for cell avoidance associated with lower layer failures in accordance with various aspects of the present disclosure. The operations of method 1200 may be implemented by a device such as a UE 115 or its components as described above. For example, the operations of method 1200 may be performed by the cell avoidance manager as described herein. In some examples, the UE 115 may execute a set of codes to control the functional elements of the device to perform the functions described below. Additionally or alternatively, the UE 115 may perform aspects of the functions described below using special-purpose hardware.

At block 1205, the UE 115 may determine that a number of failures in AS operations for a first cell has exceeded a threshold as described above with reference to FIGS. 2 and 3. In certain examples, the operations of block 1205 may be performed by the failure determining component as described with reference to FIGS. 5 and 6.

At block 1210, the UE 115 may deprioritize the first cell based on the determination that the number of failures has exceeded the threshold as described above with reference to FIGS. 2 and 3. In certain examples, the operations of block 1210 may be performed by the cell deprioritizing component as described with reference to FIGS. 5 and 6.

At block 1215, the UE 115 may determine that a number of deprioritized cells within a group of cells exceeds a deprioritization threshold, where the group of cells includes a frequency, a PLMN, or a tracking area as described above with reference to FIGS. 2 and 3. In certain examples, the operations of block 1215 may be performed by the group deprioritization component as described with reference to FIGS. 5 and 6.

At block 1220, the UE 115 may bar the group of cells for reselection for a time period based on the determination that the number of deprioritized cells exceeds the deprioritization threshold as described above with reference to FIGS. 2 and 3. In certain examples, the operations of block 1220 may be performed by the group deprioritization component as described with reference to FIGS. 5 and 6.

At block 1225, the UE 115 may select a second cell based on the deprioritization of the first cell or the barred group of cells as described above with reference to FIGS. 2 and 3. In certain examples, the operations of block 1225 may be performed by the cell selection component as described with reference to FIGS. 5 and 6.

It should be noted that the methods 800, 900, 1000, 1100, and 1200 are just example implementations, and that the operations of the methods may be rearranged or otherwise modified such that other implementations are possible. In some examples, aspects from two or more of the methods 800, 900, 1000, 1100, and 1200 described with reference to FIGS. 8, 9, 10, 11, and 12 may be combined. For example, aspects of each of the methods may include steps or aspects of the other methods, or other steps or techniques described herein. Thus, aspects of the disclosure may provide for cell avoidance associated with lower layer failures.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C., as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Thus, aspects of the disclosure may provide for cell avoidance associated with lower layer failures. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
determining that a number of failures in access stratum (AS) operations for a first cell has exceeded a threshold;
deprioritizing the first cell relative to a priority of a second cell based at least in part on the determination that the number of failures has exceeded the threshold;
selecting the second cell based at least in part on the deprioritization of the first cell; and
communicating with the second cell based at least in part on selecting the second cell.

2. The method of claim 1, further comprising:
determining that a timer associated with a non-access stratum (NAS) procedure has expired, wherein the deprioritization of the first cell is based at least in part on the expiration of the timer associated with the NAS procedure.

3. The method of claim 2, wherein the timer associated with the NAS procedure comprises an evolved packet system (EPS) mobility management (EMM) timer.

4. The method of claim 1, wherein the failures in AS operations comprise at least one of a random access operation failure, a radio resource control (RRC) connection attempt failure, an expiry of an RRC connection timer, a system information block (SIB) decode failure, or any combination thereof.

5. The method of claim 1, further comprising:
ranking the first cell among a set of deprioritized cells based at least in part on the number of failures in AS operations for the first cell.

6. The method of claim 1, wherein a set of non-deprioritized cells is ranked over a set of deprioritized cells on a same frequency, and wherein the set of non-deprioritized cells comprises the second cell and the set of deprioritized cells comprises the first cell.

7. The method of claim 1, wherein a set of non-deprioritized cells is prioritized over a set of deprioritized cells on a different frequency, and wherein the set of non-deprioritized cells comprises the second cell and the set of deprioritized cells comprises the first cell.

8. The method of claim 1, wherein a duration of the deprioritization of the first cell is based at least in part on the number of failures in AS operations exceeding the threshold within a designated time period.

9. The method of claim 8, further comprising:
determining that the duration of the deprioritization has passed; and
reprioritizing the first cell cased at least in part on the determination that the duration has passed.

10. The method of claim 1, wherein a duration of the deprioritization of the first cell is based at least in part on a type of AS operations that have failed in excess of the threshold.

11. The method of claim 1, further comprising:
receiving AS operation failure information associated with at least one other user equipment (UE) at the first cell, wherein the deprioritization of the first cell is based at least in part on the received AS operation failure information.

12. The method of claim 1, further comprising:
storing AS operation failure information for the first cell, wherein the deprioritization of the first cell is based at least in part on the stored AS operation failure information.

13. The method of claim 1, wherein the failures in AS operations comprise consecutive failures.

14. The method of claim 1, wherein deprioritizing the first cell comprises:
barring the first cell from selection or reselection, or both.

15. The method of claim 1, further comprising:
detecting the first cell and the second cell during an out-of-service (OOS) scan, wherein selecting the second cell is based at least in part on the OOS scan.

16. The method of claim 1, further comprising:
resetting the number of failures in AS operations for the first cell based at least in part on the deprioritization of the first cell or a time period between failures, or both.

17. The method of claim 1, further comprising:
determining that a reselection criterion for cell is not met based at least in part on the deprioritization of the first cell.

18. The method of claim 1, further comprising:
removing the first cell from a list of cells eligible for reselection based at least in part on the deprioritization of the first cell.

19. The method of claim 1, further comprising:
determining that a number of deprioritized cells within a group of cells exceeds a deprioritization threshold, wherein the group of cells comprises a frequency, a public land mobile network (PLMN), or a tracking area; and
barring the group of cells for reselection for a time period based at least in part on the determination that the number of deprioritized cells exceeds the deprioritization threshold.

20. The method of claim 19, further comprising:
detecting movement of a device; and
reinstating the group of cells for reselection based at least in part on the detected movement.

21. An apparatus for wireless communication comprising:
means for determining that a number of failures in access stratum (AS) operations for a first cell has exceeded a threshold;
means for deprioritizing the first cell relative to a priority of a second cell based at least in part on the determination that the number of failures has exceeded the threshold;
means for selecting the second cell based at least in part on the deprioritization of the first cell; and
means for communicating with the second cell based at least in part on selecting the second cell.

22. An apparatus for wireless communication, comprising:
a processor;
memory in electronic communication with the processor; and
instructions stored in the memory and operable, when executed by the processor, to cause the apparatus to:
determine that a number of failures in access stratum (AS) operations for a first cell has exceeded a threshold;
deprioritize the first cell relative to a priority of a second cell based at least in part on the determination that the number of failures has exceeded the threshold;
select the second cell based at least in part on the deprioritization of the first cell; and
communicate with the second cell based at least in part on selecting the second cell.

23. The apparatus of claim 22, wherein the instructions are operable to cause the apparatus to:
determine that a timer associated with a non-access stratum (NAS) procedure has expired; and
deprioritize the first cell based at least in part on the expiration of the timer associated with the NAS procedure.

24. The apparatus of claim 22, wherein the instructions are operable to cause the apparatus to:
rank the first cell among a set of deprioritized cells based at least in part on the number of failures in AS operations for the first cell.

25. The apparatus of claim 22, wherein the instructions are operable to cause the apparatus to:
rank a set of non-deprioritized cells over a set of deprioritized cells, wherein the set of non-deprioritized cells comprises the second cell and the set of deprioritized cells comprises the first cell.

26. The apparatus of claim 22, wherein a duration of the deprioritization of the first cell is based at least in part on the number of failures in AS operations exceeding the threshold within a designated time period or a type of AS operations that have failed in excess of the threshold, or both.

27. The apparatus of claim 26, wherein the instructions are operable to cause the apparatus to:
determine that the duration of the deprioritization has passed; and
reprioritize the first cell cased at least in part on the determination that the duration has passed.

28. The apparatus of claim 22, wherein the instructions are operable to cause the apparatus to:
receive AS operation failure information associated with at least one other user equipment (UE) at the first cell, wherein the deprioritization of the first cell is based at least in part on the received AS operation failure information.

29. The apparatus of claim 22, wherein the instructions are operable to cause the apparatus to:
determine that a number of deprioritized cells within a group of cells exceeds a deprioritization threshold, wherein the group of cells comprises a frequency, a public land mobile network (PLMN), or a tracking area; and
bar the group of cells for reselection for a time period based at least in part on the determination that the number of deprioritized cells exceeds the deprioritization threshold.

30. A non-transitory computer-readable medium storing code for wireless communication, the code comprising instructions executable to:
determine that a number of failures in access stratum (AS) operations for a first cell has exceeded a threshold;
deprioritize the first cell relative to a priority of a second cell based at least in part on the determination that the number of failures has exceeded the threshold;
select the second cell based at least in part on the deprioritization of the first cell; and
communicate with the second cell based at least in part on selecting the second cell.
